(19) United States
(12) Patent Application Publication
(10) Pub. No.: US 2007/0206658 A1
(43) Pub. Date: Sep. 6, 2007

(54) Wireless network system using power line communication

(76) Inventors: Sae-Rom Park, Suwon-si (KR); Ki-Yeul Kim, Seoul (KR); Kwan Hee Han, Anyang-si (KR)

Correspondence Address: JONES DAY, 222 EAST 41ST ST, NEW YORK, NY, 10017, US

(21) Appl. No.: 11/543,958

(22) Filed: Oct. 4, 2006

(30) Foreign Application Priority Data
Mar. 2, 2006 (KR) 10-2006-0020031

(51) Int. Cl. H04B 1/00

(52) U.S. Cl. 375/130

(57) ABSTRACT

A wireless network transmission system using a power line communication (PLC), which can connect at least one ultra-wideband (UWB) network by using a UWB relay and support communication between different UWB networks. The wireless network transmission system using a PLC includes: a first pico-net including at least one device generating a UWB data signal; a UWB relay unit transforming the UWB data signal into a PLC data signal; and a power line unit mechanically connecting the first pico-net and a second pico-net, and transmitting the transformed PLC data signal to the second pico-net.

### CROSS-REFERENCE TO RELATED APPLICATION

This application claims the benefit of Korean Patent Application No. 10-2006-0020031, filed on Mar. 2, 2006, in the Korean Intellectual Property Office, the disclosure of which is incorporated herein by reference.

### BACKGROUND OF THE INVENTION

1. Field of the Invention

The present invention relates to a wireless network transmission system using power line communication (PLC), and more particularly, to a wireless network transmission system which can connect at least one ultra-wideband (UWB) network by using a UWB relay to support communication between different UWB networks.

2. Description of Related Art

Since the 1960s, applications for UWB technology has been continuously researched and developed for military use, e.g. in the fields of radar, image identification of an underground facility, security, and the like, and from the 1990s, the application of UWB technology for communication use has started to develop. Currently, the UWB communication is a technology that can provide approximately 480 Mbps of wireless transmission speed under the 802.15.3a and 802.15.3b standards of the Institute of Electrical and Electronics Engineers (IEEE).

Since UWB communication supports communication only among devices within a pico-net and does not support multi-hop, data transmission in the UWB communication is not provided between different UWB networks. Also, since communication only between devices within an identical pico-net, i.e. the same UWB network, is possible, a data transmission distance is short and a communication coverage is narrow.

Also, in a conventional art, there is a communication system between a data server connected by using a power line communication (PLC) and a wireless device, however, the communication system is not a communication system between UWB networks, only a communication system having a PLC and a UWB network, which may not be a solution for communication between wireless devices. An embodiment of the UWB network system according to the conventional art is illustrated in FIG. 1.

FIG. 1 is a diagram briefly illustrating a configuration of a general UWB network system.

Referring to FIG. 1, each of pico-nets 110 and 120 includes at least a UWB device 111, 112, 113, 121, 122, and 123 having a UWB chip, and communication between devices included in an identical pico-net may be accomplished. However, as described above, in the UWB network system according to the conventional art, communication between devices, e.g. between 111 and 121, included in a pico-net which has a different identifier, is not possible.

Therefore, in order to solve the above described problem of the multi-hop, a wireless network transmission system which can transmit a UWB signal using a power line communication and broaden a range of a UWB network by minimizing an occurrence of a shadow area when connecting more than one UWB network, is earnestly required.

### BRIEF SUMMARY

The present invention provides a wireless network transmission system which can support communication between pico-nets using a high speed PLC.

The present invention also provides a wireless network transmission system which can solve a problem of a multi-hop, i.e., not capable of communication between different UWB pico-nets, by using a UWB relay.

The present invention also provides a wireless network transmission system using a PLC which can transmit a UWB data signal wherever existing power lines are connected, without an additional wire.

The present invention also provides a wireless network transmission system which can minimize an occurrence of a shadow area when networking using a wireless signal.

The present invention also provides a wireless network transmission system which can broaden a range of a UWB network by using a high speed PLC.

According to an aspect of the present invention, there is provided a wireless network transmission system including: a first pico-net including at least one device generating a UWB data signal; a UWB relay unit transforming the UWB data signal into a PLC data signal; and a power line unit mechanically connecting the first pico-net and a second pico-net, and transmitting the transformed PLC data signal to the second pico-net.

According to another aspect of the present invention, there is provided a UWB relay of a wireless network transmission system including: an antenna unit transmitting/receiving a UWB data signal transmitted from at least one device included in a first pico-net; a signal transformation unit transforming the UWB data signal into a PLC data signal; a UWB module unit identifying a pico-net identifier of the UWB data signal, and routing the UWB data signal according to the pico-net identifier; and a high speed PLC modem unit multiplexing the transformed PLC data signal to transmit to a power line unit.

### BRIEF DESCRIPTION OF THE DRAWINGS

The above and/or other aspects and advantages of the present invention will become apparent and more readily appreciated from the following detailed description, taken in conjunction with the accompanying drawings of which:

FIG. 1 is a diagram briefly illustrating a configuration of a general UWB network system;

FIG. 2 is a diagram illustrating an embodiment of a wireless network transmission system using a PLC for communication between UWB pico-nets adopting the present invention;

FIG. 3 is a diagram illustrating an embodiment of the UWB relay unit in FIG. 2;

FIG. 4 is a flowchart illustrating an embodiment of a data transmitting method of the wireless network transmission system using the PLC in FIGS. 2 and 3;

FIG. 5 is a flowchart illustrating an embodiment of a data receiving method of the wireless network transmission system using the PLC in FIGS. 2 and 3; and

FIG. 6 is a diagram illustrating an actual application example of a wireless network transmission system using a PLC.

### DETAILED DESCRIPTION OF EMBODIMENTS

Reference will now be made in detail to embodiments of the present invention, examples of which are illustrated in the accompanying drawings, wherein like reference numerals refer to the like elements throughout. The embodiments are described below in order to explain the present invention by referring to the figures.

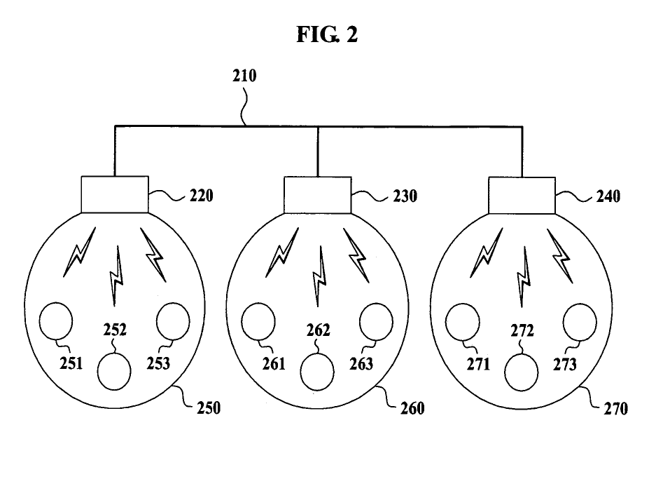

FIG. 2 is a diagram illustrating an embodiment of a wireless network transmission system using a high speed PLC for communication between UWB pico-nets adopting the present invention;

Referring to FIG. 2, the wireless network transmission system using a high speed PLC includes at least one pico-net 250, 260, and 270, a UWB relay unit 220, 230, and 240, and an existing power line unit 210.

Referring to FIG. 2, each of the at least one pico-net 250, 260, and 270 of the wireless network transmission system respectively includes UWB devices 251, 252, 253, 261, 262, 263, 271, 272 and 273, and may be identified by a typical pico-net identifier.

In order to transmit a UWB data signal generated from a first pico-net 250 to a second pico-net 260, the existing power line unit 210 connects the first pico-net 250 to the second pico-net 260. In order to transmit through the power line unit 210 of the UWB data signal, the UWB relay units 220, 230, and 240 transform the UWB data signal into a PLC data signal, route the UWB data signal according to the pico-net identifier and transmit the transformed PLC data signal. As described above, the transformed PLC data signal is transmitted to the second pico-net 260 through the power line unit 210.

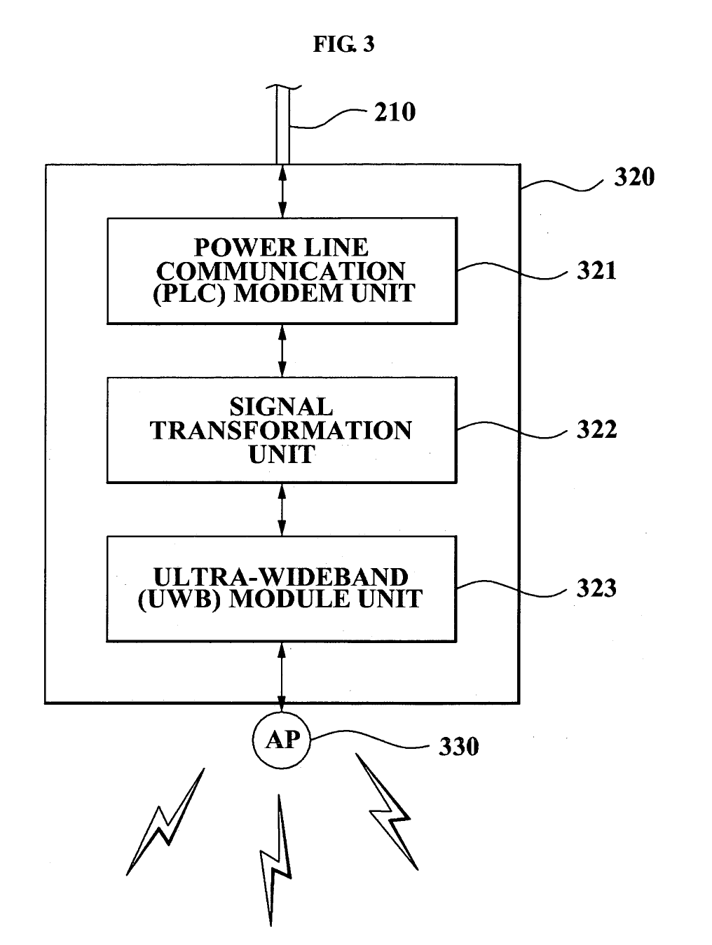

Hereinafter, a detailed configuration of a UWB relay unit will be described with reference to FIG. 3.

FIG. 3 is a diagram illustrating an embodiment of the UWB relay units 220, 230, and 240 in FIG. 2.

Referring to FIG. 3, the UWB relay unit 320 includes a PLC modem unit 321, a signal transformation unit 322, a UWB module unit 323, and an antenna unit 330.

The antenna unit 330 transmits/receives a UWB radio frequency (RF) signal between devices included in an identical pico-net to a device within the UWB relay unit 320.

The UWB module unit 323 transmits/receives data regarding a wireless communication module function for executing communication according to a UWB communication protocol and a destination address of transmitting/receiving data.

The signal transformation unit 322 transforms a signal between a UWB data signal and a PLC data signal. Specifically, the signal transformation unit 322 transforms a format of the UWB data signal into a format of the PLC data signal, and the transformed PLC data signal is transmitted to a different pico-net through the power line unit 210 to the high speed PLC modem unit 321.

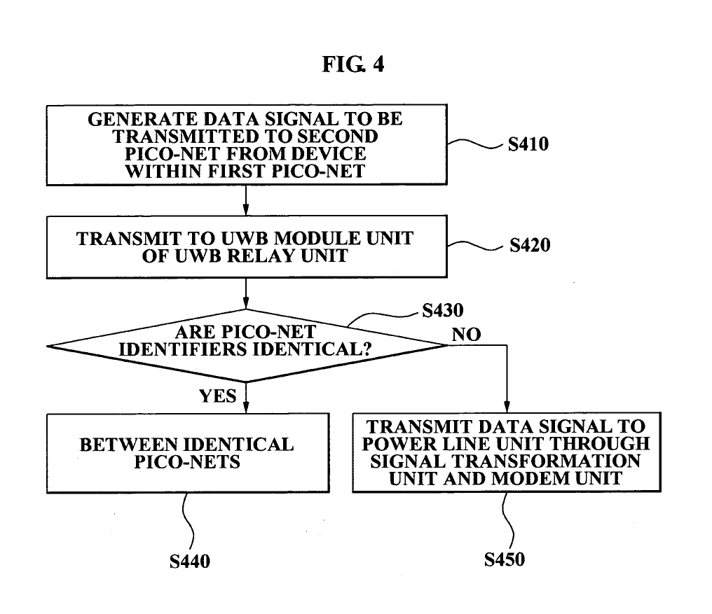

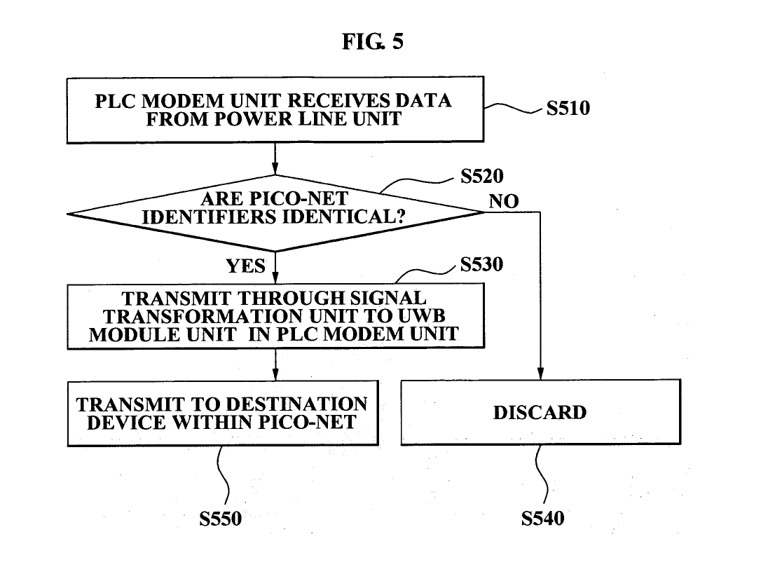

By referring to FIGS. 4 and 5, transmitting/receiving operations of the wireless network transmission system using the high speed PLC according to the present invention will be described in detail with reference to FIG. 3.

FIG. 4 is a flowchart illustrating an embodiment of a data transmitting method of the wireless network transmission system using the PLC in FIGS. 2 and 3.

Referring to FIG. 4, the data transmitting method of the wireless network transmission system using the high speed PLC according to the present invention will be illustrated in detail as below.

In operation S410, a UWB data signal is generated in a device included in a first pico-net to be transmitted to a device included in a second pico-net.

In operation S420, the generated UWB data signal is transmitted through the antenna unit 330 to the UWB module unit 323 of the UWB relay unit 320.

In operation S430, the UWB module unit 323 identifies a pico-net identifier of the UWB data signal, and when the pico-net identifier is identical to the pico-net identifier of the identifying UWB module unit 323, i.e. the pico-net identifier of the pico-net where the UWB relay unit 320 is currently located, in operation S440, the UWB module unit 323 determines the UWB data signal is a communication between devices within an identical pico-net. Also, in operation S430, when the pico-net identifier of the UWB data signal is not identical to the pico-net identifier of the pico-net where the UWB relay unit 320 is currently located, operation S450 is subsequently performed.

In the operation S450, the UWB module unit 323 relays the UWB data signal to the signal transformation unit 322. The signal transformation unit 322 transforms the UWB data signal into a PLC data signal and transmits the transformed PLC data signal to the high speed PLC modem unit 321. The high speed PLC modem unit 321 transmits the transformed PLC data signal through the power line unit 210 to a different pico-net.

FIG. 5 is a flowchart illustrating an embodiment of a data receiving method of the wireless network transmission system using the PLC in FIGS. 2 and 3.

Referring to FIG. 5, a receiving operation of a wireless network transmission system using the high speed PLC according to the present invention will be described in detail below.

In operation S510, the high speed PLC modem unit 321 receives the PLC data signal from the power line unit 210.

In operation S520, the PLC modem unit 321 identifies a pico-net identifier of the PLC data signal, and when the pico-net identifier is not identical to a the pico-net identifier of the identifying UWB module unit 323, i.e. a pico-net identifier of a pico-net where the UWB relay unit 320 is currently located, the received PLC data signal is discarded in operation S540.

Also, when the pico-net identifier of the PLC data signal is identical to the pico-net identifier of the identifying UWB module unit 323 in operation S520, the PLC modem unit 321 transmits data to the signal transformation unit 322 in operation S530. Also in operation S530, the signal transformation unit 322 transforms the PLC data signal into a UWB data signal to transmit the transformed PLC data signal to the UWB module unit 323. In operation S550, when the UWB module unit 323 receives the UWB data signal, transformed from the PLC data signal in the signal transformation unit 322, the UWB module unit 323 identifies a destination address of the UWB data signal and transmits the transformed data signal, through the antenna unit 324, to a destination device corresponding to the destination address.

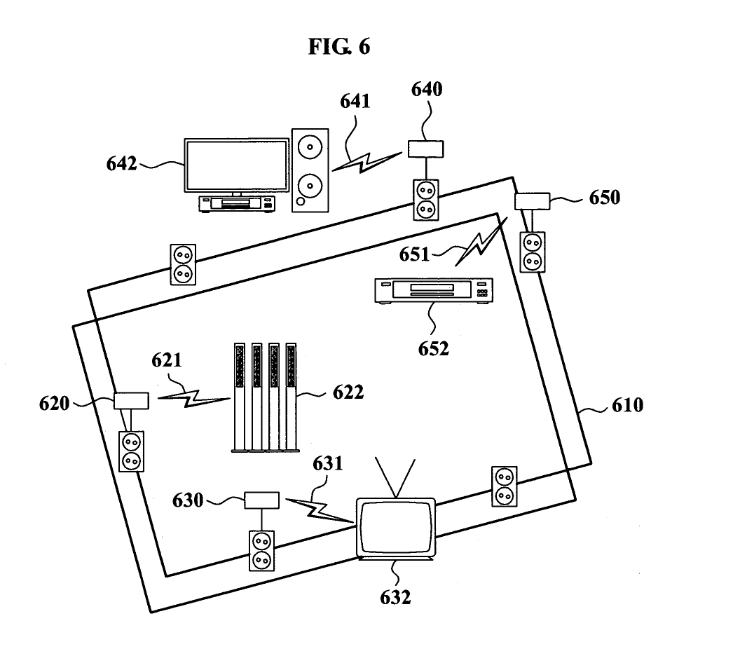

FIG. 6 is a diagram illustrating an actual application example of a wireless network transmission system using a PLC.

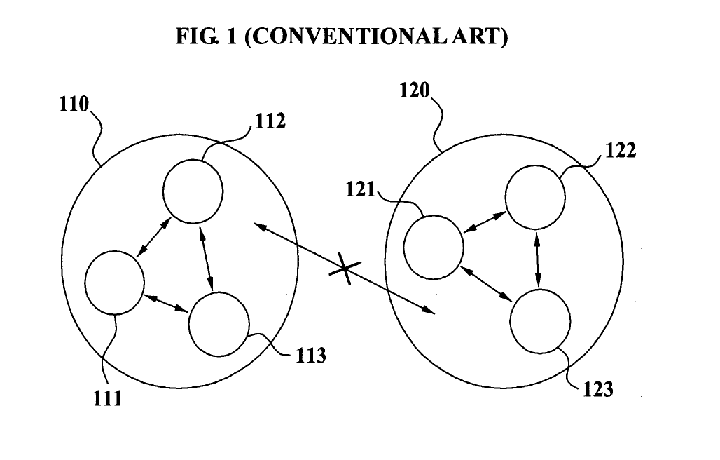

Referring to FIG. 6, data communication between pico-nets in the conventional UWB network in FIG. 1 is not possible, however, in the wireless network transmission system using the high speed PLC according to the present invention, i.e., data communication is possible between a set-top box 652 included in a first pico-net and a TV 632, a home theater 642, and a speaker 622 in separate pico-nets.

As mentioned above, the conventional wireless communication has the problem of a shadow area, conversely according to the present invention, the problem may not occur wherever additional PLC relays 620, 630, 640, and 650, are able to be established.

Also, the UWB communication is a short distance communication, so that a communication coverage is comparatively narrower and a deterioration of communication effectiveness may occur while passing through an obstacle in the UWB communication, conversely a distance limitation of the UWB network may be overcome according to the present invention. Namely, the set-top box 652 is able to be connected with the TV 632, the home theater 642, and the speaker 622, despite the fact they are relatively far from each other, therefore an application range of a UWB communication network may be increased.

According the present invention, there is provided a wireless network transmission system which can support communication between pico-nets using a high speed PLC.

According the present invention, there is provided a wireless network transmission system which can solve a problem of a multi-hop, i.e., not capable of communication between different UWB pico-nets, by using a UWB relay.

According the present invention, there is provided a wireless network transmission system using a PLC which can transmit a UWB data signal wherever existing power lines are connected, without an additional wire.

According the present invention, there is provided a wireless network transmission system which can minimize an occurrence of a shadow area when networking using a wireless signal.

According the present invention, there is provided a wireless network transmission system which can broaden a range of a UWB network by using a high speed PLC.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A wireless network transmission system comprising:
a first pico-net including at least one device generating an ultra-wideband (UWB) data signal;
a UWB relay unit transforming the UWB data signal into a power line communication (PLC) data signal; and
a power line unit mechanically connecting the first pico-net and a second pico-net, and transmitting the transformed PLC data signal to the second pico-net.

2. The system of claim 1, wherein the UWB data signal generated from the at least one device includes a pico-net identifier and a destination address.

3. The system of claim 1, the UWB relay unit comprising:
an antenna unit transmitting/receiving the UWB data signal from the at least one device included in the first pico-net;
a signal transformation unit transforming the UWB data signal into the PLC data signal;
a UWB module unit identifying a pico-net identifier of the UWB data signal, and routing the UWB data signal according to the pico-net identifier; and
a high speed PLC modem unit multiplexing the transformed PLC data signal to transmit to the power line unit.

4. A UWB relay of a wireless network transmission system, the relay comprising:
an antenna unit transmitting/receiving a UWB data signal transmitted from at least one device included in a first pico-net;
a signal transformation unit transforming the UWB data signal into a PLC data signal;
a UWB module unit identifying a pico-net identifier of the UWB data signal, and routing the UWB data signal according to the pico-net identifier; and
a high speed PLC modem unit multiplexing the transformed PLC data signal to transmit to a power line unit.
